(19) United States
(12) Patent Application Publication
(10) Pub. No.: US 2013/0009762 A1
(43) Pub. Date: Jan. 10, 2013

(54) TIRE PRESSURE SENSOR AND NOZZLE ASSEMBLY

(76) Inventors: San-Chuan Yu, Changhua County (TW); Tung-Feng Lin, Nantou County (TW)

(21) Appl. No.: 13/241,692

(22) Filed: Sep. 23, 2011

(30) Foreign Application Priority Data
Jul. 6, 2011 (TW) 100123875

(51) Int. Cl. B60C 23/02

(52) U.S. Cl. 340/442

(57) ABSTRACT

A tire pressure sensor and nozzle assembly includes a tire pressure sensor, a nozzle and a fastener for fixing the tire pressure sensor and the nozzle together. The tire pressure sensor has a mount provided with a coupling hole into which a coupling post of the nozzle is inserted. The faster penetrates into the mount and is fixed with the coupling post in such a way that the fastener extends along a direction perpendicular to an axial direction of the coupling post, such that the tire pressure sensor and the nozzle can be firmly coupled with each other.

### BACKGROUND OF THE INVENTION

1. Field of the Invention

The present invention relates generally to a tire pressure sensor and nozzle assembly for detecting and wireless transmitting the characteristic tire parameters, such as tire pressure and temperature, and more particularly, to an assembly arrangement of a tire pressure sensor and nozzle assembly, which can ensure that the tire pressure sensor and the nozzle are firmly engaged with each other.

2. Description of the Related Art

A tire-pressure monitoring system, hereinafter referred to as “TPMS”, is an electronic system designed for detecting and then notifying the real-time characteristic tire parameters, such as tire pressure and temperature, to the driver of the vehicle. Since the TPMS can enhance driving safety, more and more commercially available vehicles are equipped with the TPMS nowadays. Conventionally, the TPMS comprises a tire pressure sensor located inside the tire of the vehicle to detect the characteristic tire parameters. The detected real-time parameters are transmitted by a wireless transmitting technology to a processor for data processing, and then the parameters are converted by the processor to readable informations, which in turn are disclosed to the driver of the vehicle in a text, diagram, light or voice format.

As shown in the disclosure of U.S. Pat. No. 7,916,011 or US publication No. 2010/0024539 A1, the tire pressure sensor of the TPMS is generally coupled to a tire nozzle that is fixed to the wheel rim. In this way, the tire pressure sensor can be stationarily installed inside the tire. Taking U.S. Pat. No. 7,916,011 for example, the tire pressure sensor disclosed in this patent is provided with a coupling hole into which a coupling post of the nozzle is inserted. By means of a screw that is threaded into the coupling post of the nozzle and abutted against the tire pressure sensor, the tire pressure sensor is fixedly engaged with the nozzle. However, because the screw is threaded from the free end surface of the coupling post into inside of the coupling post along the axial direction of the coupling post and the cross-sections of the coupling post and the coupling hole are round-shaped, the fastening screw may become loose or even detached from the coupling post due to the centrifugal face caused by the rotation motion of the rolling wheel, which in turn may cause the damage of the tire pressure sensor due to the fact that the tire pressure sensor may rotate or loosen relative to the coupling post or even escape from the coupling post to hit the wheel rim during the high speed rolling of the wheel. On the other hand, the tire pressure sensor disclosed in the US patent publication No. 2010/0024539 is also provided with a coupling hole through which a threaded coupling post of the nozzle is inserted. By means of a nut screwingly sleeved onto the threaded coupling post of the nozzle and abutted against the tire pressure sensor, the tire pressure sensor is fixedly engaged with the nozzle. However, this assembly arrangement, which is similar to that of the U.S. Pat. No. 7,916,011, may encounter the aforesaid problems.

### SUMMARY OF THE INVENTION

The present invention has been accomplished in view of the above-noted circumstances. It is therefore the primary objective of the present invention to provide a tire pressure sensor and nozzle assembly having a tire pressure sensor and a nozzle, which can be firmly coupled with each other.

To achieve the above-mentioned objective, the tire pressure sensor and nozzle assembly provided by the present invention comprises a tire pressure, a nozzle and a fastener for fixing the tire pressure and the nozzle together. The tire pressure sensor has a mount provided with a coupling hole. The nozzle has a coupling post inserted into the coupling hole of the mount. The fastener penetrates into the mount and is fixed with the coupling post of the nozzle through a circumference of the coupling post of the nozzle. Since the fastener is fixed with the coupling post in such a way that the fastener extends along a direction perpendicular to the axial direction of the coupling post, the fastener will be hardly affected by the centrifugal force generated by the rotation notion of a rolling wheel to become loose, such that the nozzle and the tire pressure sensor can be firmly engaged with each other.

In a preferred embodiment of the present invention, the mount of the tire pressure sensor comprises a through hole extending along a radial direction of the coupling hole and being communicated with the coupling hole, and the coupling post of the nozzle comprises a threaded hole extending along a radial direction of the coupling post. In addition, the fastener is a screw inserted in the through hole of the mount and threaded into the threaded hole of the coupling post of the nozzle. In this way, the nozzle and the tire pressure sensor can be quickly and fixedly coupled with each other.

In a preferred embodiment of the present invention, a wall defining the coupling hole of the mount is provided with a positioning plane, and the coupling post of the nozzle is axially provided with a positioning plane. In addition, the coupling post of the nozzle is inserted into the coupling hole of the mount in a way that the positioning plane of the coupling post faces the positioning plane of the wall. In this way, it can prevent the coupling post of the nozzle from rotating inside the coupling hole relative to the tire pressure sensor. In other words, it can prevent the tire pressure sensor from rotating about the coupling post relative to the tire.

In a preferred embodiment of the present invention, the threaded hole of the coupling post inwardly extends from the positioning plane of the coupling post along the radial direction of the coupling post, and the though hole of the mount penetrates through the positioning plane of the wall. In this way, when the coupling post is inserted into the coupling hole, the through hole of the mount and the threaded hole of the coupling post can be positively and quickly aligned in a line for facilitating installation of the fastener.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is an exploded view of a tire pressure sensor and nozzle assembly according to a first preferred embodiment of the present invention;

FIG. 2 is an exploded view from another viewing angle of the tire pressure sensor and nozzle assembly shown in FIG. 1;

FIG. 3 is a perspective view of the nozzle of the tire pressure sensor and nozzle assembly shown in FIG. 1;

FIG. 4 is a schematic drawing showing that the tire pressure sensor and nozzle assembly is installed in a wheel; and

FIG. 5 is an exploded view of a tire pressure sensor and nozzle assembly according to a second preferred embodiment of the present invention.

### DETAILED DESCRIPTION OF THE INVENTION

It is to be mentioned that same or similar parts disclosed in the preferred embodiments and the drawings, which will be detailedly described hereunder, are denoted with same reference numerals for the purpose of concise illustration of the present invention.

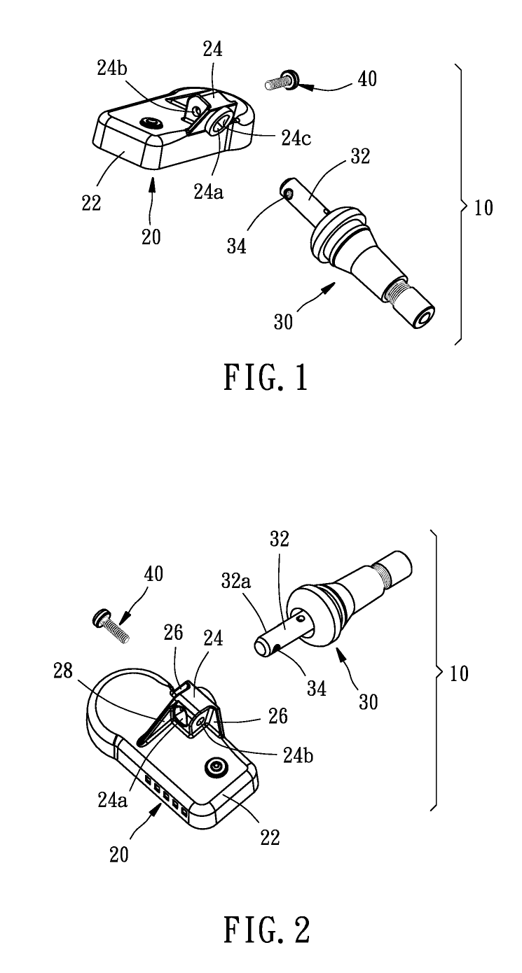

As shown in FIGS. 1-3, a tire pressure sensor and nozzle assembly, which is provided by a first preferred embodiment of the present invention and denoted by a reference numeral 10 in the drawings, comprises a tire pressure sensor 20, a nozzle 30 and a fastener 40. Hereinafter the detailed description of the aforesaid parts will be recited.

The tire pressure sensor 20 includes a shell 22 in which a circuit board, which is not shown in the drawings, for detecting and wireless transmitting the characteristic tire parameters, such as tire pressure and temperature, is installed. For the circuit board, any commercially available prior arts can be used. Since the design and function of the circuit board are not features of the present invention and have nothing to do with the issue that the present invention intends to address, the detailed description thereof will be omitted.

On a lateral side of the top surface of the shell 22 a mount 24 is provided. The mount 24 is provided with a coupling hole 24a and a through hole 24b that penetrates through the body of the mount 24 along a radial direction of the coupling hole 24a, i.e. along a direction perpendicular to the axial direction of the coupling hole 24a, such that the through hole 24b is in communication with the coupling hole 24a. A cross-section of the coupling hole 24a is not shaped like a circle, as shown in FIG. 1. Specifically speaking, the wall defining the coupling hole 24a has a protruded flat section forming a positioning plane 24c. In addition, the through hole 24b is disposed passing through the positioning plane 24c.

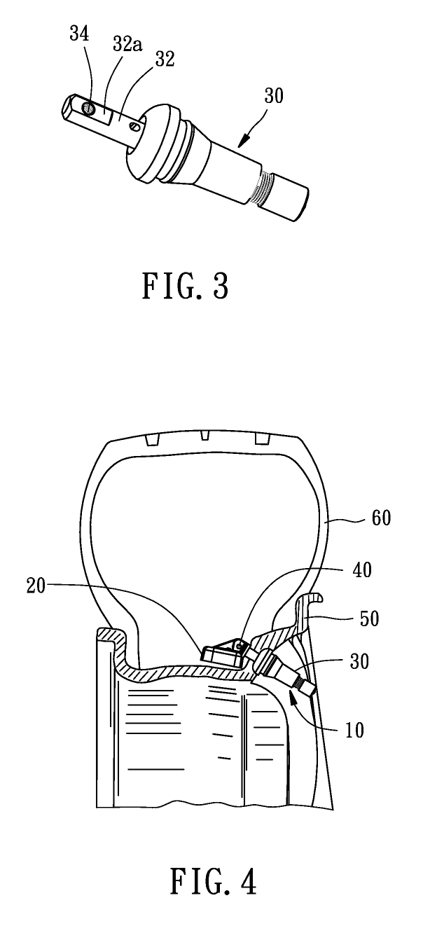

The basic structure and function of the nozzle 30 are the same as those of the commercially available prior art nozzles, except that the nozzle 30 has a coupling post 32, which is shaped like a cylindrical rod, and a threaded hole 34 provided at an end portion of the coupling post 32. The threaded hole 34 penetrates through the body of the coupling post 32 along a radial direction of the coupling post 32, i.e. along a direction perpendicular to the axial direction of the coupling post 32. However, it'll be appreciated that the extending direction of the threaded hole 34 is not limited to the aforesaid direction that is perpendicular to the axial direction of the coupling post 32. As along as the threaded hole 34 extends inwardly from the circumference of the coupling post 32, the threaded hole 34 having any extending orientations can be used. In addition, as shown in FIG. 3, the circumference of the coupling post 32 is provided with a recessed flat section extending along the axial direction of the coupling post 32 so as to form a positioning plane 32a.

In addition, the tire pressure sensor 20 further comprises two first rib plates 26, which are connected with two lateral sides of the mount 24 respectively and extend along a direction perpendicular to the coupling post 32 of the nozzle 30, and a second rib plate 28, which is connected with the mount 24 and extends along a direction parallel to the coupling post 32 of the nozzle 30, for structural reinforcement and protection.

As to the fastener 40, it is embodied as a screw in this preferred embodiment of the present invention. In fact, a rivet or other suitable fasteners can be used for the fastener 40 of the present invention. In other words, the fastener 40 can be, but not limited to, a screw.

In assembly, the coupling post 32 of the nozzle 30 is inserted into the coupling hole 24a of the mount 24 of the tire pressure sensor 20 in such a way that the positioning plane 32a of the coupling post 32 faces the positioning plane 24c of the mount 24 for facilitating the threaded hole 34 to be aligned with the through hole 24b. Thereafter, the fastener 40, i.e. screw 40, is inserted through the through hole 24b and firmly threaded into the threaded hole 34 to make the head of the fastener (screw) 40 be firmly abutted against the mount 24 of the tire pressure sensor 20, such that the nozzle 30 and the tire pressure sensor 20 can be firmly engaged with each other. After the assembly work is completed, the axial direction of the through hole 24b of the mount 24 and the axial direction of the fastener 40 are substantially parallel to the shell 22.

As can be seen from the above-mentioned description, the work of assembling the tire pressure sensor and nozzle assembly 10 of the present invention can be easily and quickly done.

FIG. 4 shows the tire pressure sensor and nozzle assembly 10 installed to a wheel rim 50 in a general manner that the tire pressure sensor 20 is located inside the tire 60. As shown in FIG. 4, the direction of the centrifugal force caused by the rotation motion of a rolling wheel 60 is substantially perpendicular to the axial direction of the fastener 40, such that the fastener 40 can hardly become loose during rolling of the wheel so as to ensure that the nozzle 30 and the tire pressure sensor 20 can be firmly engaged with each other.

In addition, the coupling post 32 of the nozzle 30 is inserted into the coupling hole 24a of the mount 24 of the tire pressure sensor 20 in such a way that the positioning plane 32a of the coupling post 32 faces the positioning plane 24c of the coupling hole 24a of the mount 24, which can prevent the coupling post 32 from rotating in the coupling hole 24a relative to the tire pressure sensor 20. In other words, this arrangement can prevent the tire pressure sensor 20 that has been firmly coupled with the coupling post 32 from rotating about the coupling post 32 relative to the wheel rim 50 so as to further prevent the tire pressure sensor 20 from hitting the wheel rim 50.

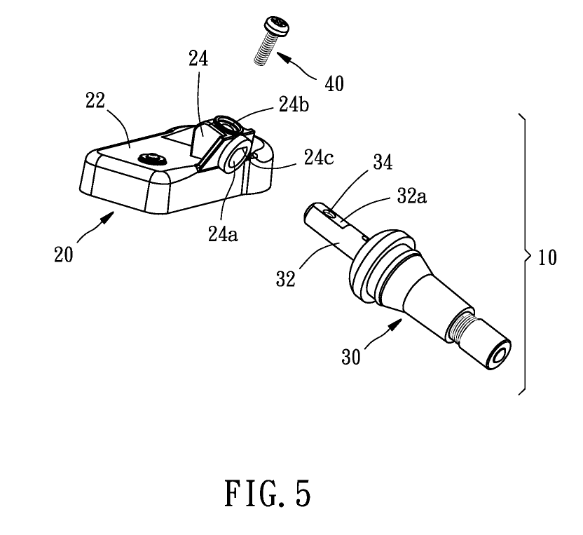

FIG. 5 illustrates a tire pressure sensor and nozzle assembly 10 in accordance with a second preferred embodiment of the present invention. The nozzle 30 and fastener (screw) 40 in this embodiment are the same as those disclosed in FIGS. 1-3. The difference between the first and second preferred embodiments lines in that the through hole 24b of the mount 24 of the tire pressure sensor 20, which is in communication with the coupling hole 24a, inwardly extends from a top surface of the body of the mount 24, i.e. the axial directions of the through hole 24b of the mount 24 and the fastener 40 extend towards the shell 22, and the through hole 24b is a counterbore. In assembly, the fastener 40 is inserted from the top surface of the mount 24 through the through hole 24b and threaded into the threaded hole 34 of the coupling post 32 of the nozzle 30 in such a manner that the head of the fastener 40 is immersed in the through hole 24b. In this way, the tire pressure sensor and nozzle assembly 10 provided by the second embodiment can also achieve the objective of the present invention.

Since the positioning plane 24c of the coupling hole 24a of the mount 24 and the positioning plane 32a of the coupling post 32 of the nozzle 30 are located adjacent to the place of the mount 24 where the head of the fastener 40 is tightly abutted against, after the fastener 40 is tightened up, the positioning plane 24c of the mount 24 and the positioning plane 32a of the nozzle 30 can be firmly fitted with each other so as to realize a stable and firm effect in assembly.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A tire pressure sensor and nozzle assembly comprising:
a tire pressure sensor having a mount provided with a coupling hole;
a nozzle having a coupling post inserted into the coupling hole of the mount; and
a fastener penetrating into the mount and being fixed with the coupling post of the nozzle through a circumference of the coupling post of the nozzle, such that the nozzle and the tire pressure sensor are firmly coupled with each other.

2. The tire pressure sensor and nozzle assembly of claim 1, wherein the mount of the tire pressure sensor comprises a through hole extending along a radial direction of the coupling hole in communication with the coupling hole, and the coupling post of the nozzle comprises a threaded hole extending along a radial direction of the coupling post; the fastener is a screw inserted in the through hole of the mount and threaded into the threaded hole of the coupling post of the nozzle.

3. The tire pressure sensor and nozzle assembly of claim 2, wherein a wall defining the coupling hole of the mount is provided with a positioning plane, and the coupling post of the nozzle is provided at the circumference thereof with a positioning plane extending along an axial direction of the coupling post; the coupling post of the nozzle is inserted into the coupling hole of the mount in a way that the positioning plane of the coupling post faces the positioning plane of the wall; the threaded hole of the coupling post radially and inwardly extends from the positioning plane of the coupling post.

4. The tire pressure sensor and nozzle assembly of claim 2, wherein the through hole of the mount is a counterbore.

5. The tire pressure sensor and nozzle assembly of claim 2, wherein the tire pressure sensor comprises a shell on which the mount is provided; an axial direction of the through hole of the mount and an axial direction of the fastener are substantially parallel to the shell.

6. The tire pressure sensor and nozzle assembly of claim 2, wherein the tire pressure sensor comprises a shell on which the mount is provided; an axial direction of the through hole of the mount and an axial direction of the fastener extend towards the shell.

7. The tire pressure sensor and nozzle assembly of claim 1, wherein a wall defining the coupling hole of the mount is provided with a positioning plane, and the coupling post of the nozzle is provided at the circumference thereof with a positioning plane extending along an axial direction of the coupling post; the coupling post of the nozzle is inserted into the coupling hole of the mount in a way that the positioning plane of the coupling post faces the positioning plane of the wall.

8. The tire pressure sensor and nozzle assembly of claim 1, wherein the fastener is fixed with the coupling post of nozzle in a way that the fastener extends along a direction perpendicular to an axial direction of the coupling post.

9. The tire pressure sensor and nozzle assembly of claim 1, wherein the tire pressure sensor comprises two rib plates connected with two lateral sides of the mount respectively and extending along a direction perpendicular to the coupling post of the nozzle.

10. The tire pressure sensor and nozzle assembly of claim 1, wherein the tire pressure sensor comprises a rib plate connected with the mount and extending along a direction parallel to the coupling post of the nozzle.
